(19) United States
(12) Patent Application Publication
(10) Pub. No.: US 2014/0380292 A1
(43) Pub. Date: Dec. 25, 2014

(54) METHOD, DEVICE, AND STORAGE MEDIUM FOR UPGRADING OPERATING SYSTEM

(71) Applicant: Xiaomi Inc., Beijing (CN)

(72) Inventors: Yi Ru, Beijing (CN); Xiaohe Yang, Beijing (CN)

(73) Assignee: Xiaomi Inc., Beijing (CN)

(21) Appl. No.: 14/281,915

(22) Filed: May 20, 2014

Related U.S. Application Data
(63) Continuation-in-part of application No. PCT/CN2014/072319, filed on Feb. 20, 2014.

(30) Foreign Application Priority Data
Jun. 25, 2013 (CN) 201310256345.9

(51) Int. Cl. G06F 9/445

(52) U.S. Cl. CPC G06F 8/65
USPC 717/168

(57) ABSTRACT

The present disclosure discloses a method, a device, and a storage medium for upgrading an operating system. The method includes: determining a current operating system in use; synchronizing system files of the current operating system to a mirror operating system; obtaining an operating system upgrade package; upgrading the mirror operating system according to the operating system upgrade package; starting the mirror operating system after the mirror operating system is successfully upgraded; and using the mirror operating system as the current operating system. In the present disclosure, the operating system upgrade does not influence normal use of the current operating system, which prevents accidents or errors from occurring in the upgrading of the operating system that might results in a malfunction of the current operating system, and thus increases safety and stability of the operating system.

### CROSS REFERENCE TO RELATED APPLICATION

This application is a Continuation-In-Part of International Application NO. PCT/CN2014/072319, filed Feb. 20, 2014, which is based upon and claims priority to Chinese Patent Application No. 201310256345.9, filed Jun. 25, 2013, the entire contents of which are incorporated herein by reference.

### TECHNICAL FIELD

The present disclosure generally relates to the field of information technology, and particularly, to a method, a device, and a storage medium for upgrading an operating system.

### BACKGROUND

As the hardware structures of smart electronic terminal device become more and more similar, the core values and technologies of various kinds of terminal devices are reflected in functions of operating systems of the terminal devices. The terminal devices equipped with operating systems having high maturity and accomplished functions have relatively high competitiveness in market competition. In order to guarantee the stability of the operating systems and completeness of the functions, the operating systems in the terminal devices are required to be upgraded frequently. Thus, how to safely and quickly upgrade a current operating system is the key to guarantee safety and stability of the operating system.

Currently, when the current operating system is to be upgraded, a corresponding operating system upgrade package is downloaded via a network, and then the current operating system will restart after the download is completed. The downloaded operating system upgrade package is operated to upgrade the current operating system, and then the current operating system will be restarted after the upgrade is completed, and at this time, the operating system will be the upgraded operating system.

For an upgrade scheme of the above operating system, given that the current operating system is upgraded, if accidents or errors such as system power-off or an abnormal operating system upgrade have occurred in the upgrade of the operating system, it will result in the malfunction of the current operating system, thereby decreasing safety and stability of the operating system. In addition, when the entire process for upgrading the operating system is performed after the operating system is restarted, the operating system cannot be used while the operating system is being upgraded.

### SUMMARY

According to a first aspect of the embodiments of the present disclosure, there is provided a method for upgrading an operating system of a device, comprising: determining a current operating system in use; synchronizing system files of the current operating system to a mirror operating system; obtaining an operating system upgrade package; upgrading the mirror operating system according to the operating system upgrade package; starting the mirror operating system after the mirror operating system is successfully upgraded; and using the mirror operating system as the current operating system.

According to a second aspect of the embodiments of the present disclosure, there is provided a device for upgrading an operating system, comprising: a processor; and a memory for storing instructions executable by the processor, for performing a method comprising: determining a current operating system in use; synchronizing system files of the current operating system to a mirror operating system; obtaining an operating system upgrade package; upgrading the mirror operating system according to the operating system upgrade package; starting the mirror operating system after the mirror operating system is successfully upgraded; and using the mirror operating system as the current operating system.

According to a third aspect of the embodiments of the present disclosure, there is provided a non-transitory computer-readable storage medium having stored therein instructions that, when executed by a processor of a device, causes the device to perform method for upgrading an operating system, the method comprising: determining a current operating system in use; synchronizing system files of the current operating system to a mirror operating system; obtaining an operating system upgrade package; upgrading the mirror operating system according to the operating system upgrade package; starting the mirror operating system after the mirror operating system is successfully upgraded; and using the mirror operating system as the current operating system.

The technical solutions provided by the embodiments of the present disclosure may include the following beneficial effects: system files of a current operating system are synchronized to a corresponding mirror operating system, an operating system upgrade is performed in the synchronized mirror operating system, the upgraded mirror operating system is started after the mirror operating system is successfully upgraded, and the upgraded mirror operating system is used as the current operating system, such that the operating system upgrade does not influence normal use of the current operating system. Meanwhile, the upgrade is performed in the mirror operating system, which prevents from the case where accidents have occurred in the upgrade of the operating system that results in that the current operating system can not be normally used, and thus increases safety and stability of the operating system.

It should be understood that both the above general description and the following detailed description are only illustrative and explanatory, which do not limit the present disclosure.

### BRIEF DESCRIPTION OF THE DRAWINGS

The accompanying drawings incorporated below constitute a part of this specification, which illustrate the embodiments of the present disclosure, and together with the specification serve to explain the principles of the present disclosure.

FIG. 1 is a flowchart illustrating a method for upgrading an operating system of a device according to an embodiment of the present disclosure;

FIG. 2 is a flowchart illustrating a method for upgrading an operating system of a device according to an embodiment of the present disclosure;

FIG. 3 is a block diagram illustrating a first type of apparatus for upgrading an operating system according to an embodiment of the present disclosure;

FIG. 4 is a block diagram illustrating a second type of apparatus for upgrading an operating system according to an embodiment of the present disclosure;

FIG. 5 is a block diagram illustrating a third type of apparatus for upgrading an operating system according to an embodiment of the present disclosure;

FIG. 6 is a block diagram illustrating a fourth type of apparatus for upgrading an operating system according to an embodiment of the present disclosure; and

FIG. 7 is a block diagram illustrating a device according to an embodiment of the present disclosure.

### DETAILED DESCRIPTION

In order to make the purposes, technical solutions and advantages of the present disclosure more apparent, hereinafter, the embodiments of the present disclosure will be further described in detail in conjunction with the accompanying drawings. The implementations set forth in the following description of exemplary embodiments do not represent all implementations consistent with the invention. Instead, they are merely examples of apparatuses and methods consistent with aspects related to the invention as recited in the appended claims.

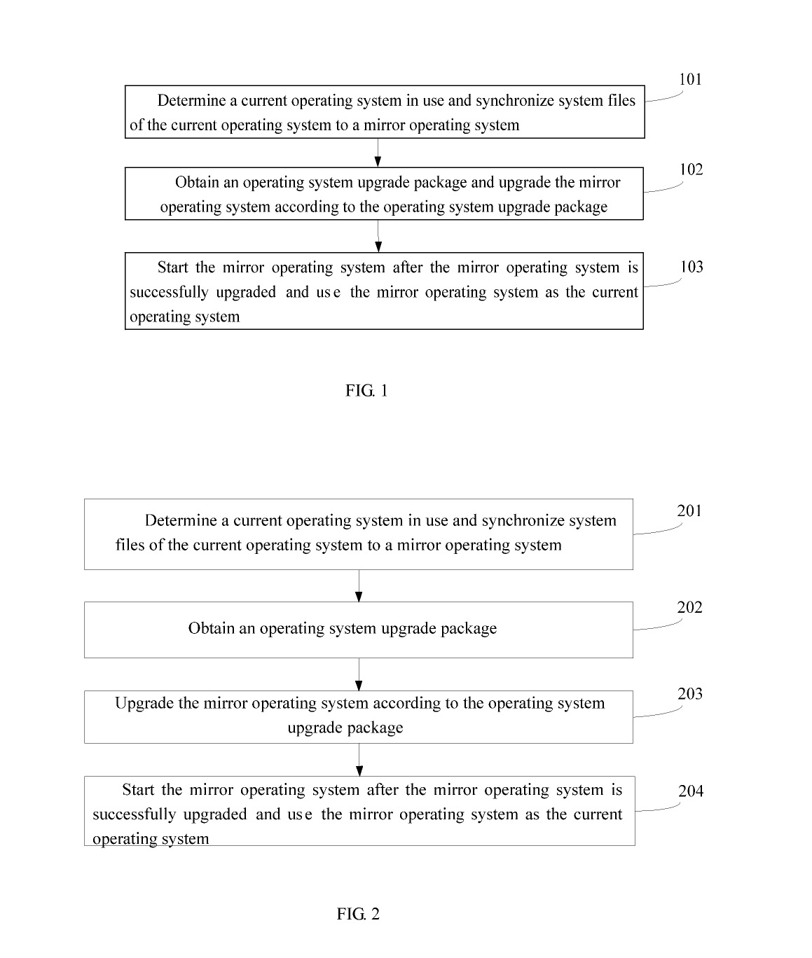

The present embodiment provides a method for upgrading an operating system of a device, with reference to FIG. 1, the steps of the method provided by the present embodiment may be shown as below.

In step 101, the method includes determining a current operating system in use.

In step 102, the method includes synchronizing system files of the current operating system to a mirror operating system.

In one embodiment, the system files of the current operating system include BOOT files and SYSTEM files.

The step of synchronizing the system files of the current operating system to the mirror operating system may include: synchronizing the BOOT files of the current operating system to the mirror operating system, and synchronizing the SYSTEM files of the current operating system to the mirror operating system after the BOOT files are successfully synchronized.

In step 103, the method includes obtaining an operating system upgrade package.

In step 104, the method includes upgrading the mirror operating system according to the operating system upgrade package.

In one embodiment, before obtaining the operating system upgrade package, the method may further include: searching whether a corresponding operating system upgrade package is present in the network, and displaying a prompt indicating that the corresponding operating system upgrade package is present if the corresponding operating system upgrade package is present, to allow a user to confirm according to the prompt whether to upgrade the current operating system.

For example, the step of obtaining the operating system upgrade package includes: downloading the corresponding operating system upgrade package from the network after obtaining information indicating to upgrade the current operating system determined by the user.

In step 105, the method includes starting the mirror operating system after the synchronized mirror operating system is successfully upgraded.

In step 106, the method includes using the mirror operating system as the current operating system.

In one embodiment, before starting the mirror operating system after the synchronized mirror operating system is successfully upgraded, the method may further include: setting and displaying a starting identifier, to allow a user to confirm according to the starting identifier whether to start the mirror operating system;

For example, the step of starting of the upgraded mirror operating system includes: performing an operation of starting the mirror operating system after obtaining information indicating that the user determines to start the mirror operating system.

In one embodiment, after using the mirror operating system as the current operating system, the method may further include: synchronizing system files of the mirror operating system to a previous operating system.

In the method provided by the present embodiment, system files of the current operating system are synchronized to the mirror operating system, and the operating system upgrade is performed in the mirror operating system, then the mirror operating system is started after the mirror operating system is successfully upgraded, thus the mirror operating system can be used as the current operating system. In the present embodiment, the operating system upgrade does not influence normal use of the current operating system, which prevents accidents or errors from occurring in the upgrading of the operating system that might results in a malfunction of the current operating system, and thus increases safety and stability of the operating system.

In order to clearly explain the method for upgrading an operating system provided by the above embodiment, combining the contents of the above embodiment and taking the following second embodiment as an example, a method for upgrading an operating system is explained in detail in the second embodiment.

The present embodiment provides a method for upgrading an operating system in a device, the operating system to be upgraded in the present embodiment includes two synchronized operating systems, and any one of the two operating systems that is used in the device is a current operating system, the other operating system (not used) is a mirror operating system corresponding to the current operating system. With reference to FIG. 2, the steps of the method provided by the present embodiment may be shown as follows.

In step 201, the method includes determining the current operating system.

In step 202, the method includes synchronizing system files of the current operating system to the mirror operating system.

When step 201 and 202 are specifically performed, the present embodiment does not limit a specific time at which step 201 and 202 are performed. For example, in order to guarantee synchronization between the current operating system and the mirror operating system, a synchronizing period may be preset, by which step 201 and 202 are periodically performed. Moreover, the present embodiment does not limit a specific length of the preset synchronizing period, for example, the synchronizing period may be preset to be a week or a day. Besides, step 201 and 202 may also be performed while it is determined that an operating system upgrade is required to be performed in accordance with the method for upgrading the operating system provided by the present embodiment.

In addition, the system files of the current operating system include BOOT files and SYSTEM files. Thus, when the step of synchronizing the system files of the current operating system to the mirror operating system is implemented, it is required to synchronize the BOOT files of the current operating system to the mirror operating system, and to synchronize the SYSTEM files of the current operating system to the mirror operating system after the BOOT files are successfully synchronized. If the process of synchronizing the BOOT files of the current operating system to the mirror operating system fails, or the process of synchronizing the SYSTEM files of the current operating system to the mirror operating system fails, the synchronizing process between the current operating system and the mirror operating system is determined to be unsuccessful. In order to successfully perform subsequent processes for upgrading the operating system, the method provided by the present embodiment may repeatedly perform the synchronizing process between the two operating systems until the synchronization succeeds, and then subsequent upgrade steps can be continue. Accordingly, there may be other specific method for implementing the step of synchronizing the system files of the current operating system to the mirror operating system. The present embodiment does not limit the method for implementing the step of synchronizing the system files of the current operating system to the mirror operating system.

In step 203, the method includes obtaining an operating system upgrade package.

With respect to this step, the present embodiment does not limit a specific method of obtaining an upgrade package. The method may include downloading a corresponding operating system upgrade package from a network, but it is not limited thereto.

In one embodiment, in order to make the method for upgrading the operating system provided by the present embodiment be more conforming to a user's actual needs, before obtaining the operating system upgrade package, the device searches whether a corresponding operating system upgrade package is present in the network, and a prompt is displayed if the corresponding operating system upgrade package is present, to allow a user to confirm according to the prompt whether to perform the operating system upgrade; and the corresponding operating system upgrade package is downloaded from the network after information indicating to perform the operating system upgrade determined by the user is obtained.

The present embodiment does not limit a specific search time of determining whether the corresponding operating system upgrade package is present in the network. For example, a search period may be preset, such that the device periodically searches whether the corresponding operating system upgrade package is present in the network. Wherein, the preset search period can be any period of time, for example, the search period may be set to an hour or a day or the like. Furthermore, the present embodiment does not limit a specific search method for searching whether the corresponding operating system upgrade package is present in the network. The method may include determining a version number of the current operating system, and searching whether the operating system upgrade package corresponding to the version number is present in the network according to the version number of the current operating system, but it is not limited thereto. The present embodiment does not limit a specific displaying method for displaying a prompt indicating that the corresponding operating system upgrade package is present. The method may include popping up a prompt window indicating that the corresponding operating system upgrade package is present, but it is not limited thereto. The present embodiment does not limit a specific determining method for obtaining information indicating that the user determines to perform the operating system upgrade. The method may include using obtained information indicating that the user clicks a specified button in the prompt window, which indicates that the user determines to perform the operating system upgrade, but it is not limited thereto.

Note that, considering the present embodiment does not limit the specific search time for determining whether the corresponding operating system upgrade package is present in the network, if it is determined that the corresponding operating system upgrade package is present in the network before step 201 and 202, and the confirmation information indicating that the user determines to perform the operating system upgrade is obtained, step 203 of downloading the corresponding operating system upgrade package form the network is performed directly in the current operating system, and then step 201 and 202 are performed, at this time, the operating system upgrade package included in the mirror operating system is the operating system upgrade package that is synchronized from the current operating system. If it is determined that the corresponding operating system upgrade package is present in the network after step 201 and 202, and the confirmation information indicating that the user determines to perform the operating system upgrade is obtained, step 203 is performed in the mirror operating system to download the corresponding operating system upgrade package form the network after step 201 and 202 are performed, at this time, the operating system upgrade package included in the mirror operating system is the operating system upgrade package that is downloaded from the network. Thus, the present embodiment does not limit a specific sequence of performing steps 201, 202 and 203.

In step 204, the method includes upgrading the mirror operating system according to the operating system upgrade package.

With respect to this step, the present embodiment does not limit a specific upgrading method for upgrading the mirror operating system according to the operating system upgrade package. For example, the obtained operating system upgrade package is analyzed, and it is determined whether the analysis is normal according to a digital signature, and if the analysis is normal, files in the operating system upgrade package are updated to the mirror operating system in a manner of patches in the mirror operating system.

In step 205, the method includes starting the mirror operating system after the mirror operating system is successfully upgraded.

In step 206, the method includes using the mirror operating system as the current operating system.

With respect to these steps, the present embodiment does not limit a specific time at which the mirror operating system is started. For example, after the mirror operating system is successfully upgraded, the mirror operating system may be started when the operating system is restarted. For another example, after the mirror operating system is successfully upgraded, a starting identifier may be set and displayed to allow a user to confirm according to the starting identifier whether to start the mirror operating system, and an operation of starting the mirror operating system is performed after information indicating that the user determines to start the mirror operating system is obtained. A specific method for setting the starting identifier includes setting a specific parameter that represents the starting identifier, but it is not limited thereto. The parameter value is used as an indicator, which determines whether to start the mirror operating system or not. For example, when the parameter value is 0, it is a non-starting identifier, and when the parameter value is 1, it is a starting identifier. Certainly, the starting identifier may also use other numerical numbers to represent non-starting or starting. The present embodiment does not limit specific numerical numbers by which the starting identifier represents non-starting or starting. The present embodiment further does not limit a specific method for displaying the starting identifier. The method may include displaying the starting identifier in a manner of popping up a prompt window of the starting identifier to allow the user to confirm whether to start the mirror operating system by clicking the prompt window, or displaying a button that represents the starting identifier to make the user determines whether to start the mirror operating system by clicking the button, but it is not limited thereto. After information indicating that the user clicks the prompt window or the button that represents the starting identifier is obtained, the obtained information indicating that the user clicks the prompt window or the button may be used as the obtained information indicating that the user determines to start the mirror operating system. The present embodiment does not limit a specific obtaining method for obtaining information indicating that the user determines to start the mirror operating system.

In one embodiment, in order to maintain synchronization between the current operating system and the mirror operating system, after the mirror operating system is used as the current operating system, system files of the mirror operating system are synchronized to a previous operating system. The present embodiment does not limit a specific synchronizing method for synchronizing the system files of the mirror operating system to the previous operating system. For example, BOOT files and SYSTEM files of the mirror operating system may be synchronized to the previous operating system in accordance with the specific synchronizing method in the step 201 and 202, the details of which can be found in the step 202 is omitted here.

In the method provided by the present embodiment, system files of the current operating system are synchronized to the mirror operating system, and the operating system upgrade is performed in the mirror operating system, then the mirror operating system is started after the mirror operating system is successfully upgraded, thus the mirror operating system can be used as the current operating system. In the present embodiment, the operating system upgrade does not influence normal use of the current operating system, which prevents accidents or errors from occurring in the upgrading of the operating system that might results in a malfunction of the current operating system, and thus increases safety and stability of the operating system.

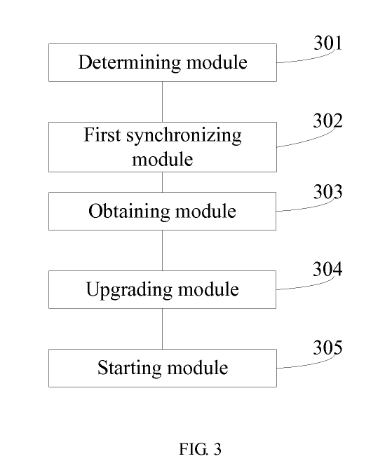

The present embodiment provides an apparatus for upgrading an operating system, and the apparatus is configured to perform the methods for upgrading the operating system provided by the above embodiments. With reference to FIG. 3, the apparatus may include: a determining module 301 configured to determine a current operating system; a first synchronizing module 302 configured to synchronize system files of the current operating system determined by the determining operating system 301 to a mirror operating system; an obtaining module 303 configured to obtain an operating system upgrade package; an upgrading module 304 configured to upgrade the mirror operating system according to the operating system upgrade package obtained by the obtaining module 303; and a starting module 305 configured to start the mirror operating system after the mirror operating system is successfully upgraded, and to use the upgraded mirror operating system as the current operating system.

In one embodiment, the system files of the current operating system include BOOT files and SYSTEM files.

The first synchronizing module 302 is configured to synchronize the BOOT files of the current operating system to the mirror operating system, and to synchronize the SYSTEM files of the current operating system to the mirror operating system after the BOOT files are successfully synchronized.

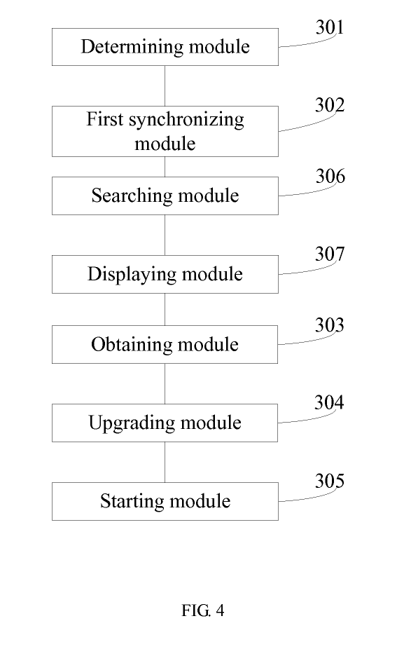

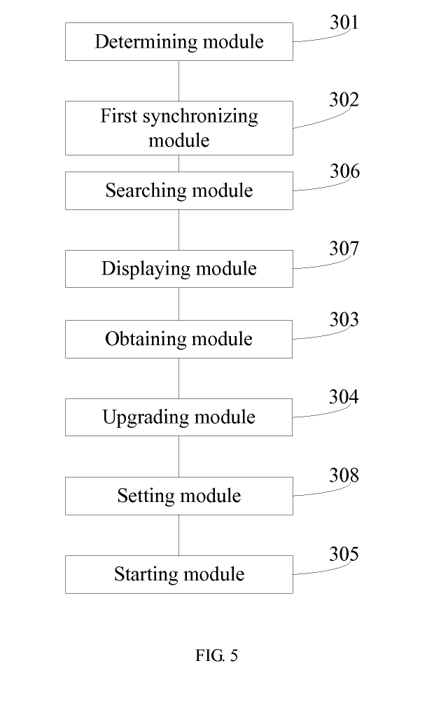

With reference to FIG. 4, the apparatus may further include: a searching module 306 configured to search whether a corresponding operating system upgrade package is present in the network; and a displaying module 307 configured to display a prompt indicating that the corresponding operating system upgrade package is present when the searching module 306 determines that the corresponding operating system upgrade package is present to allow a user to confirm according to the prompt whether to perform a operating system upgrade.

For example, the obtaining module 303 is configured to download the corresponding operating system upgrade package from the network after obtaining information indicating that the user determines to perform the operating system upgrade.

With reference to FIG. 5, the apparatus may further include: a setting module 308 configured to set and display a starting identifier to allow a user to confirm according to the starting identifier whether to start the mirror operating system.

For example, the starting module 305 is configured to perform an operation of starting the upgraded mirror operating system after the obtained information indicates that the user determines to start the upgraded mirror operating system.

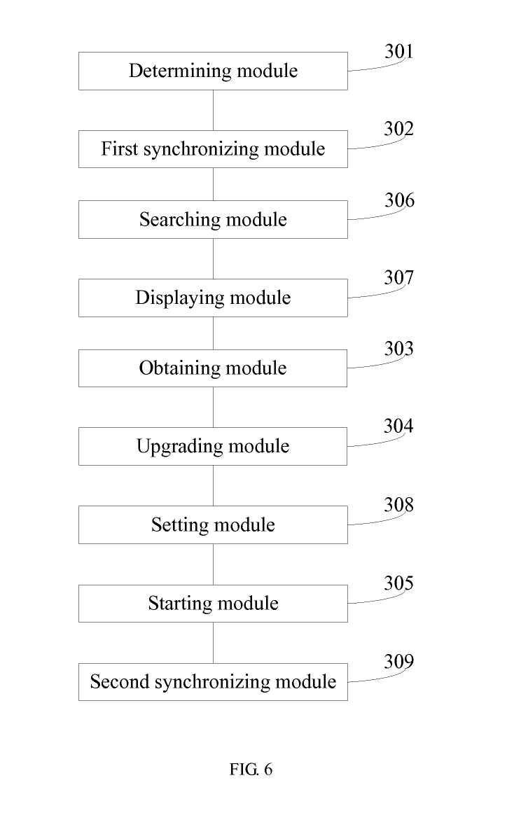

With reference to FIG. 6, the apparatus may further include: a second synchronizing module 309 configured to synchronize system files of the mirror operating system to a previous operating system.

In the apparatus provided by the present embodiment, system files of the current operating system are synchronized to the mirror operating system, and the operating system upgrade is performed in the mirror operating system, then the mirror operating system is started after the mirror operating system is successfully upgraded, thus the mirror operating system can be used as the current operating system. In the present embodiment, the operating system upgrade does not influence normal use of the current operating system, which prevents accidents or errors from occurring in the upgrading of the operating system that might results in a malfunction of the current operating system, and thus increases safety and stability of the operating system.

The embodiments of the present disclosure provide a device for performing the methods for upgrading the operating system provided by the above embodiments.

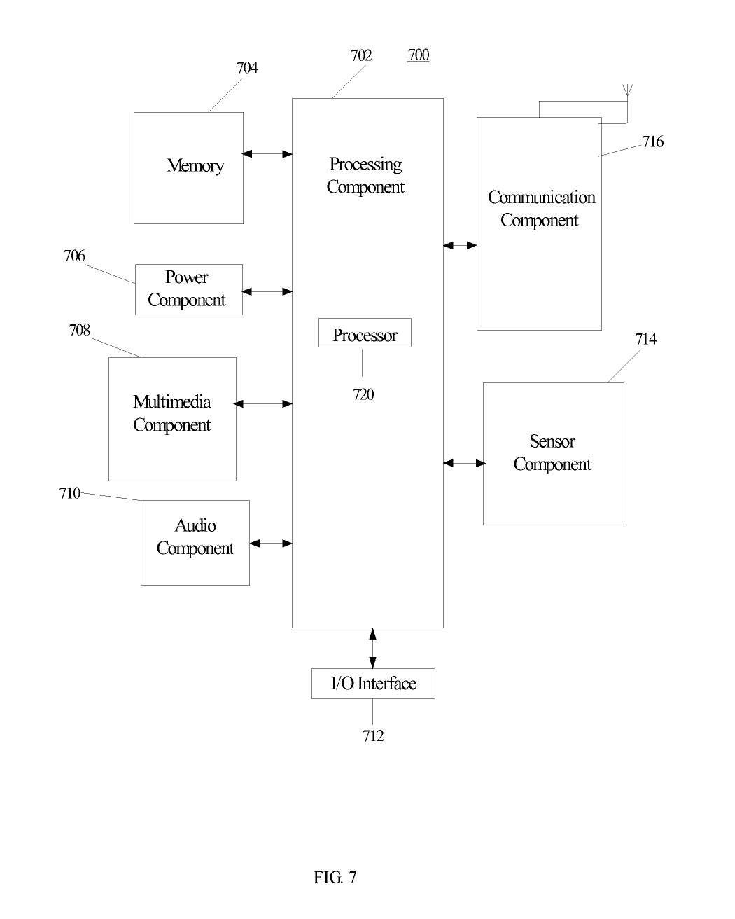

FIG. 7 is a block diagram of a device 700 for performing the methods for upgrading the operating system, according to an exemplary embodiment. For example, the device 700 may be a mobile phone, a computer, a digital broadcast terminal, a messaging device, a gaming console, a tablet, a medical device, exercise equipment, a personal digital assistant, and the like.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In the device provided by the present embodiment, system files of the current operating system are synchronized to the mirror operating system, and the operating system upgrade is performed in the mirror operating system, then the mirror operating system is started after the mirror operating system is successfully upgraded, thus the mirror operating system can be used as the current operating system. In the present embodiment, the operating system upgrade does not influence normal use of the current operating system, which prevents accidents or errors from occurring in the upgrading of the operating system that might results in a malfunction of the current operating system, and thus increases safety and stability of the operating system.

When the device and apparatus provided by the above embodiments realizes the operating system upgrade, the division of the above function modules is described only for illustration, and in actual applications, the above function allocation may be implemented by different function modules as needed. That is, the internal structure of the apparatus is divided into different function modules, to realize all or a part of the above-described functions. In addition, the device and the apparatus for upgrading the operating system and the method for upgrading the operating system provided by the above embodiments belong to the same inventive concept, and their specific implementing processes may be found in the embodiments of the method, so verbosity is omitted here.

The numbering of the above embodiments of the present disclosure is only for description, and not to represent the preference of the embodiments.

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a ROM, a RAM, a CD-ROM, a magnetic tape, a floppy disc, an optical data storage device, and the like.

The above contents are only the embodiments of the present disclosure, which are not used to limit the present disclosure. Any changes, equal substitution and modifications, etc., within the concept and principle of the present disclosure should be included in the protection scope of the present disclosure.

What is claimed is:

1. A method for upgrading an operating system of a device, comprising:
determining a current operating system in use;
synchronizing system files of the current operating system to a mirror operating system;
obtaining an operating system upgrade package;
upgrading the mirror operating system according to the operating system upgrade package;
starting the mirror operating system after the mirror operating system is successfully upgraded; and
using the mirror operating system as the current operating system.

2. The method according to claim 1, wherein the system files of the current operating system comprise BOOT files and SYSTEM files.

3. The method according to claim 2, wherein synchronizing the system files of the current operating system to the mirror operating system comprises:
synchronizing the BOOT files of the current operating system to the mirror operating system; and
synchronizing the SYSTEM files of the current operating system to the mirror operating system after the BOOT files are successfully synchronized.

4. The method according to claim 1, wherein before obtaining the operating system upgrade package, the method further comprises:
searching whether a corresponding operating system upgrade package is present in a network; and
if the corresponding operating system upgrade package is present, displaying a prompt indicating that the corresponding operating system upgrade package is present to allow a user to confirm whether to upgrade the current operating system according to the prompt.

5. The method according to claim 4, wherein obtaining the operating system upgrade package comprises:
downloading the corresponding operating system upgrade package from the network after obtaining confirmation information indicating that the user determines to upgrade the current operating system.

6. The method according to claim 1, wherein before starting the mirror operating system, the method further comprises:
setting and displaying a starting identifier to allow a user to confirm according to the starting identifier whether to start the upgraded mirror operating system.

7. The method according to claim 6, wherein starting the upgraded mirror operating system comprises:
performing an operation of starting the mirror operating system after obtaining the confirmation information indicating that the user determines to start the mirror operating system.

8. The method according to claim 1, wherein after using the mirror operating system as the current operating system, the method further comprises:
synchronizing system files of the mirror operating system to a previous operating system in use.

9. A device, comprising:
a processor; and
a memory for storing instructions executable by the processor, for performing a method comprising:
determining a current operating system in use;
synchronizing system files of the current operating system to a mirror operating system;
obtaining an operating system upgrade package;
upgrading the mirror operating system according to the operating system upgrade package;
starting the mirror operating system after the mirror operating system is successfully upgraded; and
using the mirror operating system as the current operating system.

10. The device according to claim 9, wherein the system files of the current operating system comprise BOOT files and SYSTEM files.

11. The device according to claim 10, wherein synchronizing the system files of the current operating system to the mirror operating system comprises:
synchronizing the BOOT files of the current operating system to the mirror operating system; and
synchronizing the SYSTEM files of the current operating system to the mirror operating system after the BOOT files are successfully synchronized.

12. The device according to claim 9, wherein before obtaining the operating system upgrade package, the method further comprises:
searching whether a corresponding operating system upgrade package is present in a network; and
if the corresponding operating system upgrade package is present, displaying a prompt indicating that the corresponding operating system upgrade package is present to allow a user to confirm whether to upgrade the current operating system according to the prompt.

13. The device according to claim 12, wherein obtaining the operating system upgrade package comprises:
downloading the corresponding operating system upgrade package from the network after obtaining confirmation information indicating that the user determines to upgrade the current operating system.

14. The device according to claim 9, wherein before starting the mirror operating system, the method further comprises:
setting and displaying a starting identifier to allow a user to confirm according to the starting identifier whether to start the upgraded mirror operating system.

15. The device according to claim 14, wherein starting the upgraded mirror operating system comprises:
performing an operation of starting the mirror operating system after obtaining the confirmation information indicating that the user determines to start the mirror operating system.

16. The device according to claim 9, wherein after using the mirror operating system as the current operating system, the method further comprises:
synchronizing system files of the mirror operating system to a previous operating system in use.

17. A non-transitory computer-readable storage medium having stored therein instructions that, when executed by a processor of a device, causes the device to perform method for upgrading an operating system, the method comprising:
determining a current operating system in use;
synchronizing system files of the current operating system to a mirror operating system;
obtaining an operating system upgrade package;
upgrading the mirror operating system according to the operating system upgrade package;
starting the mirror operating system after the mirror operating system is successfully upgraded; and
using the mirror operating system as the current operating system.

18. The storage medium according to claim 17, wherein the system files of the current operating system comprise BOOT files and SYSTEM files.

19. The storage medium according to claim 17, wherein before obtaining the operating system upgrade package, the method further comprises:
searching whether a corresponding operating system upgrade package is present in a network; and
if the corresponding operating system upgrade package is present, displaying a prompt indicating that the corresponding operating system upgrade package is present to allow a user to confirm whether to upgrade the current operating system according to the prompt.

20. The storage medium according to claim 17, wherein before starting the mirror operating system, the method further comprises:
setting and displaying a starting identifier to allow a user to confirm according to the starting identifier whether to start the upgraded mirror operating system.
